(19) United States
(12) Patent Application Publication
(10) Pub. No.: US 2023/0093528 A1
(43) Pub. Date: Mar. 23, 2023

(54) INTERPRETATION METHOD FOR NEURAL NETWORK MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Ying SUN, Beijing (CN); Hengshu Zhu, Beijing (CN); Chuan Qin, Beijing (CN); Fuzhen Zhuang, Beijing (CN); Hui Xiong, Beijing (CN)

(21) Appl. No.: 18/070,775

(22) Filed: Nov. 29, 2022

(30) Foreign Application Priority Data
Jan. 19, 2022 (CN) 202210062363.2

(51) Int. Cl. G06N 3/04; G06N 3/08

(52) U.S. Cl. CPC G06N 3/04; G06N 3/08

(57) ABSTRACT

An interpretation method for a neural network model is provided. Input data and output data corresponding to the input data of a neural network model are acquired, in which the neural network model includes layers of networks connected sequentially, and each layer of network corresponds to a plurality of candidate concepts. A key inference path through which the output data is obtained by the neural network model based on the input data are acquired, in which the key inference path includes target concepts respectively used by the layers of networks when the input data is processed in the neural network model, in which the target concepts are selected from the plurality of candidate concepts. Interpretation information corresponding to the layers of networks is determined according to the target concepts corresponding to the layers of networks, respectively. The key inference path and the interpretation information are output.

### CROSS-REFERENCE TO RELATED APPLICATION

This application is based on and claims priority to Chinese Patent Application No. 202210062363.2, filed on Jan. 19, 2022, the entire contents of which are incorporated herein by reference.

### FIELD

The present disclosure relates to the technical field of artificial intelligence, specifically to the technical field of deep learning, and especially to an interpretation method and an interpretation apparatus for a neural network model, an electronic device, and a storage medium.

### BACKGROUND

With the rapid development of machine learning and data mining technology, neural network technology has improved the expressiveness and adaptability of models to complex data input. However, the self-interpretability of models is crucial in the process of mining complex rules and knowledge from a large amount of data and making judgments.

### SUMMARY

The present disclosure provides an interpretation method and an interpretation apparatus for a neural network model, an electronic device, a storage medium, and a computer program product.

According to a first aspect of the present disclosure, there is provided an interpretation method for a neural network model, the method including: acquiring input data and output data corresponding to the input data of a neural network model, in which the neural network model includes layers of networks connected sequentially, and each layer of network corresponds to a plurality of candidate concepts; acquiring a key inference path through which the output data is obtained by the neural network model based on the input data, in which the key inference path includes target concepts respectively used by the layers of networks when the input data is processed in the neural network model, in which the target concepts are selected from the plurality of candidate concepts; determining interpretation information corresponding to the layers of networks according to the target concepts corresponding to the layers of networks, respectively; and outputting the key inference path and the interpretation information.

According to a second aspect of the present disclosure, there is provided an electronic device. The electronic device includes a processor and a memory, in which the processor is configured to run a program corresponding to an executable program code by reading the executable program code stored in the memory to implement the interpretation method for the neural network model as proposed above in the first aspect.

According to a third aspect of the present disclosure, there is provided a computer-readable storage medium having stored therein a computer program that, when executed by a processor, causes the processor to implement the interpretation method for the neural network model as proposed above in the first aspect.

According to a fourth aspect of the present disclosure, there is provided a computer program product including instructions that, when executed by a processor, causes the processor to implement the interpretation method for the neural network model as proposed above in the first aspect.

It is to be understood that what is described in this section is not intended to identify key or important features of embodiments of the present disclosure, nor is it intended to limit the scope of the present disclosure. Other features of the present disclosure will be readily understood through the following specification.

### BRIEF DESCRIPTION OF THE DRAWINGS

The accompanying drawings are used for a better understanding of an embodiment and do not constitute a limitation of the present disclosure.

FIG. 1 is a schematic flow diagram showing an interpretation method for a neural network model according to an embodiment of the present disclosure.

FIG. 2 is a schematic diagram showing a structure of a neural network model according to an embodiment of the present disclosure.

FIG. 3 is a schematic flow diagram showing an interpretation method for a neural network model according to an embodiment of the present disclosure.

FIG. 4 is a schematic flow diagram showing an interpretation method for a neural network model according to an embodiment of the present disclosure.

FIG. 5 is a schematic flow diagram showing an interpretation method for a neural network model according to an embodiment of the present disclosure.

FIG. 6 is a schematic diagram showing an interpretation apparatus for a neural network model according to an embodiment of the present disclosure.

FIG. 7 is a schematic diagram showing an interpretation apparatus for a neural network model according to another embodiment of the present disclosure.

FIG. 8 is a block diagram showing an electronic device used to implement an interpretation method for a neural network model according to an embodiment of the present disclosure.

### DETAILED DESCRIPTION

Illustrative embodiments of the present disclosure are described below with reference to the accompanying drawings, in which various details of the embodiments of the present disclosure are included to facilitate understanding, and they should be regarded as being merely illustrative. Therefore, those skilled in the art should realize that various changes and modifications can be made to the embodiments described herein without departing from the scope and spirit of the present disclosure. Similarly, for the sake of clarity and brevity, descriptions of well-known functions and structures are omitted from the following description.

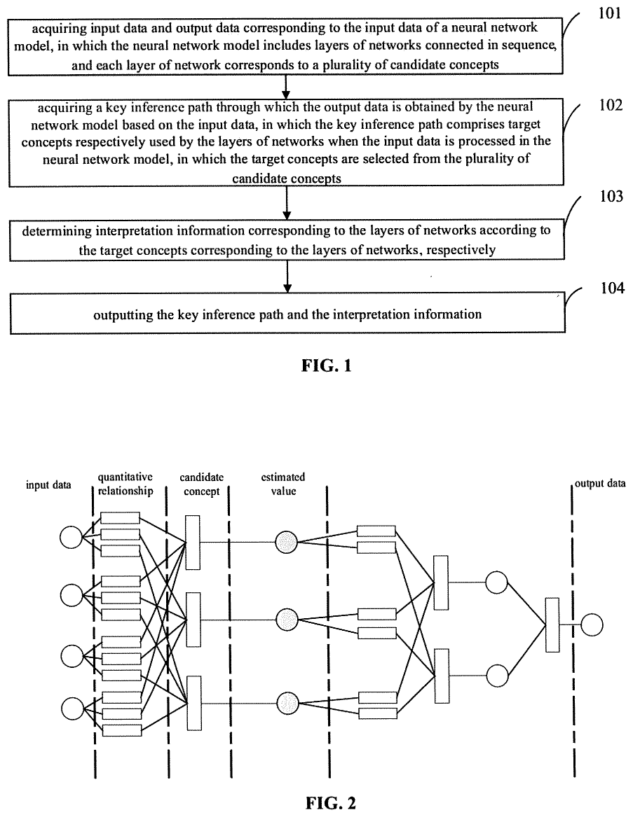

FIG. 1 is a schematic flow diagram showing an interpretation method for a neural network model according to an embodiment of the present disclosure. As shown in FIG. 1, the interpretation method for the neural network model includes the following steps 101 to 104.

In step 101, input data and output data corresponding to the input data of a neural network model are acquired, in which the neural network model includes layers of networks connected sequentially, and each layer of network corresponds to a plurality of candidate concepts.

Embodiments of the present disclosure are exemplified by the fact that the interpretation method for the neural network model is configured in the interpretation apparatus for the neural network model, which can be applied to any electronic device so that the electronic device can perform the interpretation function for the neural network model.

The electronic device may be any device having computational capabilities, for example, it may be a personal computer (PC), a server, a mobile terminal, and the like. The mobile terminal may be, for example, a mobile phone, a tablet computer, a personal digital assistant, a wearable device, and other hardware devices having various operating systems.

In some embodiments of the present disclosure, the neural network model includes layers of networks connected sequentially, and each layer of network corresponds to a plurality of candidate concepts. Candidate concepts in each layer of network correspond to hidden units in each layer of network. In the embodiment, each hidden unit corresponds to one candidate concept.

An illustrative diagram of the structure of the neural network model is shown in FIG. 2. Specifically, after a value of each observed variable in the input data is input to the neural network model, and an estimated value of a candidate concept in a first layer of network transformed from the value of the corresponding observed variable can be determined according to a quantitative relationship between the observed variables and the corresponding candidate concepts in the first layer of network. For each candidate concept in the first layer of network, estimated values of the candidate concept transformed from values of observed variables in the input data may be weighted and summed to obtain an estimated value of the candidate concept.

It is to be understood that for different application scenarios, neural network models used in different application scenarios are different, and the observed variables corresponding to different application scenarios are different.

For example, the different application scenarios can be other application scenarios, such as estimating whether a student can get high marks in an exam or classifying an apple. The neural network models used in the different application scenarios are different, and the respective observed variables and individual observed indices are also different. For example, in order to estimate whether a student can get high marks in an exam, the observed variable could be “how hard the student works”. For further clear interpretation, other observed variables can be obtained, such as “whether the student goes to the library regularly”, or “how well the student turns in homework”, or “whether the student skips class”. For example, in order to classify an apple, the observed variables can be the size, color, skin texture and other observed variables of the apple.

It is to be understood that candidate concepts in a K^{th} layer of network are upper concepts of candidate concepts in a (K−1)^{th} layer of network, where K is a positive integer from 2 to N.

For each candidate concept in the K^{th} layer of network, the estimated value of the candidate concept are determined by acquiring estimated values of candidate concepts in the (K−1)^{th} layer of network transformed into the candidate concept in the K^{th} layer of network, and weighting and summing the estimated values of the candidate concepts in the (K−1)^{th} layer of network transformed into the candidate concept in the K^{th} layer of network to obtain the estimated value of the candidate concept, in which K is a positive integer from 2 to N.

The estimated values of candidate concepts in the (K−1)^{th} layer of network transformed into the candidate concept in the K^{th} layer of network are determined based on the quantitative relationship between the candidate concepts in the (K−1)^{th} layer of network and the candidate concept in the Km layer of network. The estimated value of the corresponding candidate concept in the (K−1)′h layer of network transformed into the candidate concept in the K^{th} layer of network indicates the degree of conformity of the corresponding candidate concept in the (K−1)^{th} layer of network with the candidate concept in the K^{th} layer of network. It is to be understood that the higher the degree of conformity, the greater the corresponding estimated value is, and vice versa.

In some embodiments, the above-mentioned estimated value may be represented in the form of probability values, and in other embodiments, the above-mentioned estimated value may be represented in the form of fractions. In practical application, the representation form of the estimated value may be determined according to the needs of the actual application scenarios, which is not specifically limited in the embodiment.

For example, assuming that K is equal to 2, a first layer of network includes three candidate concepts, i.e. candidate concept A, candidate concept B, and candidate concept C, respectively, and a second layer of network includes two candidate concepts, i.e. candidate concept D, and candidate concept E. Assuming that the estimated value of the candidate concept D in the second layer of network needs to be calculated now, a quantitative relationship of the candidate concept A transformed into the candidate concept D is H1, a quantitative relationship of the candidate concept B transformed into the candidate concept D is H2, and a quantitative relationship of the candidate concept C transformed into the candidate concept D is H3. At this time, an estimated value of the candidate concept A can be input into the quantitative relationship H1 to obtain an estimated value hap of the candidate concept A transformed into the candidate concept D. The estimated value hap can indicate the degree of conformity of the candidate concept A with the candidate concept D. In addition, an estimated value of the candidate concept B can be input into the quantitative relationship H2 to obtain an estimated value h_{BD} of the candidate concept B transformed into the candidate concept D. In addition, an estimated value of the candidate concept C can be input into the quantitative relationship H3 to obtain an estimated value h_{CD} of the candidate concept C transformed into the candidate concept D. Then, the estimated value h_{AD}, the estimated value him, and the estimated value h_{CD} are weighted and summed to obtain the estimated value of the candidate concept D in the second layer of network, in which a formula to calculate an estimated value Y of the candidate concept D in the second layer of network is as follows.

Y=W₁*h_{AD}+W₂*h_{AD}+W₃*h_{AD},

where W₁ represents a weight of the candidate concept A on the candidate concept D, W₂ represents a weight of the candidate concept B on the candidate concept D, and W₃ represents a weight of the candidate concept A on the candidate concept D.

It is to be noted that quantitative relationships can be used to quantify relationships between explicit concepts with different physical meanings. In some embodiments, the quantitative relationship in the embodiments can be a univariate nonlinear function.

In step 102, a key inference path through which the output data is obtained by the neural network model is acquired based on the input data, in which the key inference path includes target concepts respectively used by the layers of networks when the input data is processed in the neural network model, in which the target concepts are selected from the plurality of candidate concepts.

For example, the target concept used by each layer of network is one of the plurality of candidate concepts.

In some embodiments of the present disclosure, one possible implementation of acquiring the key inference path through which the output data is obtained by the neural network model based on the input data is recursively identifying target concepts in layers of networks from the output from top to bottom with a network layer of the output data as a last layer.

Specifically, the last layer of network corresponding to the output data can be acquired, and each candidate concept in the last layer can be taken as a target concept, and the target concept in each layer of network can be identified according to the importance of the quantitative relationships recursively from backward to forward to the input layer, and then a key inference path of a model can be composed. After finding the key inference path of the model, the target concepts in layers of networks can be identified and recorded from the bottom up along the key inference path.

In some embodiments, one or more of the above key inference paths may be provided.

In some embodiments, an illustrative implementation of acquiring the key inference path through which the output data is obtained by the neural network model based on the input data may be acquiring, for each layer of network, respective estimated values of a plurality of candidate concepts in a current layer of network, and selecting a candidate concept with a largest estimated value as a target concept from the plurality of candidate concepts.

Other ways of acquiring the key inference path through which the output data is obtained by the neural network model based on the input data will be described in subsequent embodiments.

In step 103, interpretation information corresponding to the layers of networks is determined according to the target concepts corresponding to the layers of networks, respectively.

In some embodiments of the present disclosure, interpretations for different layers may be generated from top to bottom for a sample or for a whole task according to the generated key inference paths, and thus key concepts, key inference paths from concepts to outputs, and a transformation process can be shown to a user.

It is to be noted that the model can automatically generate interpretations for different layers. In the process of generating interpretations for different layers by the model, it is not necessary to provide concept information for the model, and the concept information can be obtained by model learning.

In step 104, the key inference path and the interpretation information are output. In some embodiments, the key inference path and the interpretation information may be output by way of a display. For example, the key inference path and the interpretation information may be displayed in an interactive interface of an electronic device.

In some embodiments of the present disclosure, the interpretation information may include semantic information of the target concept.

The semantic information of the target concept may be an intuitive interpretation of the concept.

In some embodiments of the present disclosure, in order to give more interpretation information, the above interpretation information may include semantic information and an estimated value of the target concept.

In some embodiments of the present disclosure, in order to give more interpretation information and achieve a more comprithensive interpretation of output results of the model, the above interpretation information may further include sample characteristics of a target sample corresponding to the target concept.

In some embodiments of the present disclosure, the sample characteristics of the target sample corresponding to the target concept may be intermediate sample values in a voting process, that is, the estimation of a lower concept r to an upper concept j in the layers of networks.

The interpretation method for the neural network model provided by embodiments of the present disclosure includes: acquiring input data and output data corresponding to the input data of a neural network model, in which the neural network model includes layers of networks connected sequentially, and each layer of network corresponds to a plurality of candidate concepts; acquiring a key inference path through which the output data is obtained by the neural network model based on the input data, in which the key inference path includes target concepts respectively used by the layers of networks when the input data is processed in the neural network model, in which the target concepts are selected from the plurality of candidate concepts; determining interpretation information corresponding to the layers of networks according to the target concepts corresponding to the layers of networks, respectively; and outputting the key inference path and the interpretation information. Therefore, an interpretation method for a neural network model is proposed.

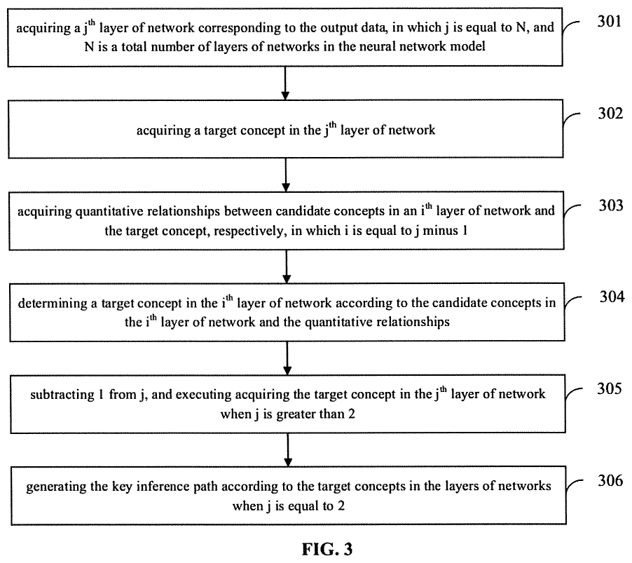

In some embodiments of the present disclosure, one possible implementation of step 102 for acquiring the key inference path through which the output data is obtained by the neural network model based on the input data, as shown in FIG. 3, may include steps 301 to 306 as follows.

In step 301, a j^{th} layer of network corresponding to the output data is acquired, in which j is equal to N, and N is the total number of layers of networks in the neural network model.

It is to be understood that the above-mentioned j^{th} layer of network is a last layer of network corresponding to the output data. A value of the total number of the layers of networks in the neural network model may be N, that is, the value of j at this time is equal to the value of N.

In step 302, a target concept in the j^{th} layer of network is acquired.

In some embodiments, in the process of processing the input data by the neural network model, there are estimated values of individual candidate concepts in each layer of network in the neural network model. Therefore, for the j^{th} layer of network, the respective estimated values of a plurality of candidate concepts in the j^{th} layer of network may be acquired, and a candidate concept with a largest estimated value may be taken as a target concept in they layer. In other embodiments, for a j^{th} layer of network, one of the plurality of candidate concepts corresponding to the j^{th} layer of network may be randomly selected as a target concept. The manner of determining the target concept in the j^{th} layer of network is not specifically limited in the embodiment.

In step 303, quantitative relationships between candidate concepts in an i^{th} layer of network and the target concept are acquired, respectively, in which i is equal to j minus 1.

In some embodiments, by recurring from the last layer of network of the model from top to bottom, a quantitative relationship between each candidate concept in a next layer of network of the last layer of network and the target concept is acquired, that is, a layer of network at this time is an i^{th} layer, in which a value of i is equal to j minus 1.

In step 304, a target concept in the i^{th} layer of network is determined according to the candidate concepts in the i^{th} layer of network and the quantitative relationships.

Specifically, among a plurality of candidate concepts of the layer, a target concept in the i^{th} layer of network may be found according to each candidate concept in the i^{th} layer of network and the quantitative relationship.

In some embodiments, determining the target concept in the i^{th} layer of network according to the candidate concepts in the i^{th} layer of network and the quantitative relationships may be achieved in various ways, and one illustrative implementation may include acquiring importance values of the quantitative relationships, ranking candidate concepts in the in layer of network in the order of importance from large to small, and taking the candidate concept ranked in a first place as the target concept in the i^{th} layer of network.

In step 305, 1 is subtracted from j, and acquiring the target concept in the j^{th} layer of network is executed when j is greater than 2.

Specifically, in the process of recursion of a model from the last layer of network from top to bottom, every recursion needs to subtract 1 from j. When a value of a new j generated after subtracting 1 from j is greater than 2, it means that a layer of network at this time has not reached a first layer, that is, an input layer, then the step of acquiring the target concept in the j^{th} layer of network is proceeded.

In step 306, the key inference path is generated according to the target concepts in the layers of networks when j is equal to 2.

Specifically, in the process of recursion of the model from the last layer of network from top to bottom, every recursion needs to subtract 1 from j. When a value of a new j generated after subtracting 1 from j is equal to 2, it means that the recursion at this time has reached the first layer, that is, the input layer, and the key inference path can be found according to the step of generating the key inference path.

In the embodiment, target concepts in the layers of networks are gradually determined from the top to bottom starting from the output, and a key inference path for processing the input data to obtain the output data by the neural network model is accurately generated based on the target concepts in the layers of networks, thus accurately reflecting an inference logic inside the neural network model and improving an interpretability of the model.

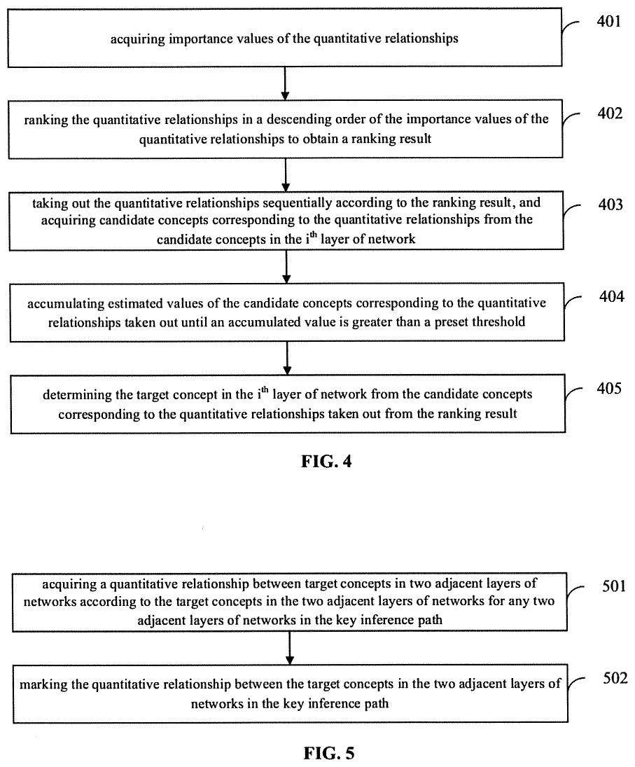

In some embodiments of the present disclosure, in order that the target concept in the j^{th} layer of network can be accurately determined, one possible implementation of step 304 for determining the target concept in the i^{th} layer of network according to the candidate concepts in the i^{th} layer of network and the quantitative relationships, as shown in FIG. 4, may include steps 401 to 405 as follows.

In step 401, importance values of the quantitative relationships are acquired.

In some embodiments, the importance values of the quantitative relationships may be acquired according to pre-stored correspondences between the quantitative relationships and the importance values.

In some embodiments, after the training of the neural network model is completed, the importance values of the quantitative relationships in the neural network model may be determined, and the correspondences between the quantitative relationships and the importance values can be stored in advance.

In step 402, the quantitative relationships are ranked in a descending order of the importance values of the quantitative relationships to obtain a ranking result.

In step 403, the quantitative relationships are taken out sequentially according to the ranking result, and candidate concepts corresponding to the quantitative relationships are acquired from the candidate concepts in the i^{th} layer of network.

In step 404, estimated values of the candidate concepts corresponding to the quantitative relationships taken out are accumulated until an accumulated value is greater than a preset threshold.

Specifically, the estimated values of the candidate concepts corresponding to the quantitative relationships taken out are summed until a summed value is greater than the preset threshold.

The preset threshold is a preset critical value of the summed value of the estimated values of the candidate concepts.

In step 405, the target concept in the i^{th} layer of network is determined from the candidate concepts corresponding to the quantitative relationships taken out from the ranking result.

Specifically, when the number of the candidate concepts corresponding to the quantitative relationships taken out from the ranking result is greater than one, one of the candidate concepts may be selected as the target concept in the i^{th} layer of network.

When the number of the candidate concepts corresponding to the quantitative relationships taken out from the ranking result is one, the candidate concept corresponding to the quantitative relationship taken out from the ranking result may be selected as the target concept in the i^{th} layer of network.

For example, assuming that i is equal to 2, j is equal to 3, and a target concept in a 3^{rd} layer of network is candidate concept D. Assuming that a 2^{nd} layer of network includes three candidate concepts, i.e. candidate concept A, candidate concept B, and candidate concept C, respectively, and that a quantitative relationship of the candidate concept A transformed into the candidate concept D is H1, a quantitative relationship of the candidate concept B transformed into the candidate concept D is H2, and a quantitative relationship of the candidate concept C transformed into the candidate concept D is H3. The quantitative relationships are ranked in a descending order of the importance values of the quantitative relationships, and a ranking result is: quantitative relationship H3, quantitative relationship H12, and quantitative relationship H1. At this time, the quantitative relationship H3 can be first taken out from the ranking result, and the candidate concept corresponding to the quantitative relationship H3 can be determined to be the candidate concept C from a plurality of candidate concepts in the 2^{nd} layer of network, and it can be determined whether an estimated value of the candidate concept C is greater than or equal to a preset threshold. When the estimated value of the candidate concept C is less than the preset threshold, the quantitative relationship H2 is subsequently taken out from the ranking result, and a candidate concept corresponding to the quantitative relationship H2 is determined to be the candidate concept B from the plurality of candidate concepts in the 2^{nd} layer of network, and an estimated value of the candidate concept A and an estimated value of the candidate concept B are summed, and it is determined whether a summed value is greater than or equal to the preset threshold. When the summed value is greater than or equal to the preset threshold, either the candidate concept B or the candidate concept C is selected as the target concept in the 2^{nd} layer of network. When the summed value is less than the preset threshold, the corresponding quantitative relationships are subsequently read from the ranking result, and it is determined whether an accumulated value of estimated values of the candidate concepts corresponding to all the quantitative relationships taken out is greater than or equal to the preset threshold until the accumulated value is greater than the preset threshold.

In an embodiment of the present disclosure, in order to enable a user to know more about the processing of the neural network model, it is also possible to mark the quantitative relationships between the target concepts in two adjacent layers of networks in the key inference path. As shown in FIG. 5, the method may further include steps 501 to 502 as follows.

In step 501, a quantitative relationship between target concepts in two adjacent layers of networks is acquired according to the target concepts in the two adjacent layers of networks for any two adjacent layers of networks in the key inference path.

Specifically, in one or more key inference paths of a model, a voting channel between the target concepts in any two adjacent layers of networks is the quantitative relationship between the target concepts in the two adjacent layers of networks.

In step 502, the quantitative relationship is marked between the target concepts in the two adjacent layers of networks in the key inference path.

Specifically, in any two adjacent layers of networks, according to the influence of a lower concept i on an estimated value of an upper concept j, significantly high, general, and significantly low samples can be screened out, and their characteristic differences can be marked.

The interpretation method for the neural network model provided in the embodiment can effectively interpret the model by analyzing the target concepts in the layers of networks layer by layer and providing a user with corresponding interpretation information for each layer of network, thus improving the self-interpretability of the model.

In correspondence to the interpretation method for the neural network model provided by the above-mentioned embodiments, an embodiment of the present disclosure also provides an interpretation apparatus for a neural network model. Since the interpretation apparatus for the neural network model provided in an embodiment of the present disclosure corresponds to the interpretation method for the neural network model provided by the above-mentioned embodiments, the implementation of the interpretation method for the neural network model is also applicable to the interpretation apparatus for the neural network model provided by the embodiments of the present disclosure, which will not be described in detail in the following embodiments.

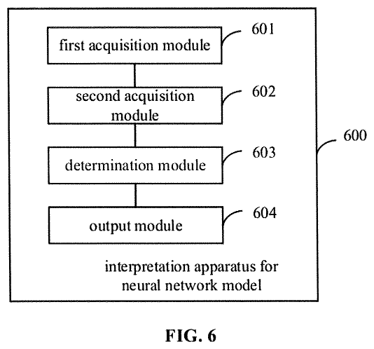

FIG. 6 is a schematic diagram showing an interpretation apparatus for a neural network model according to an embodiment of the present disclosure. As shown in FIG. 6, the interpretation apparatus 600 for the neural network model includes a first acquisition module 601, a second acquisition module 602, a determination module 603, and an output module 604.

The first acquisition module 601 is configured to acquire input data and output data corresponding to the input data of a neural network model, in which the neural network model includes layers of networks connected sequentially, and each layer of network corresponds to a plurality of candidate concepts.

The second acquisition module 602 is configured to acquire a key inference path through which the output data is obtained by the neural network model based on the input data, in which the key inference path includes target concepts respectively used by the layers of networks when the input data is processed in the neural network model, in which the target concepts are selected from the plurality of candidate concepts.

The determination module 603 is configured to determine interpretation information corresponding to the layers of networks according to the target concepts corresponding to the layers of networks, respectively.

The output module 604 is configured to output the key inference path and the interpretation information.

The interpretation apparatus for the neural network model provided by embodiments of the present disclosure is configured for acquiring input data and output data corresponding to the input data of a neural network model, in which the neural network model includes layers of networks connected sequentially, and each layer of network corresponds to a plurality of candidate concepts; acquiring a key inference path through which the output data is obtained by the neural network model based on the input data, in which the key inference path includes target concepts respectively used by the layers of networks when the input data is processed in the neural network model, in which the target concepts are selected from the plurality of candidate concepts; determining interpretation information corresponding to the layers of networks according to the target concepts corresponding to the layers of networks, respectively; and outputting the key inference path and the interpretation information. Thus, an interpretation apparatus for a neural network model is proposed.

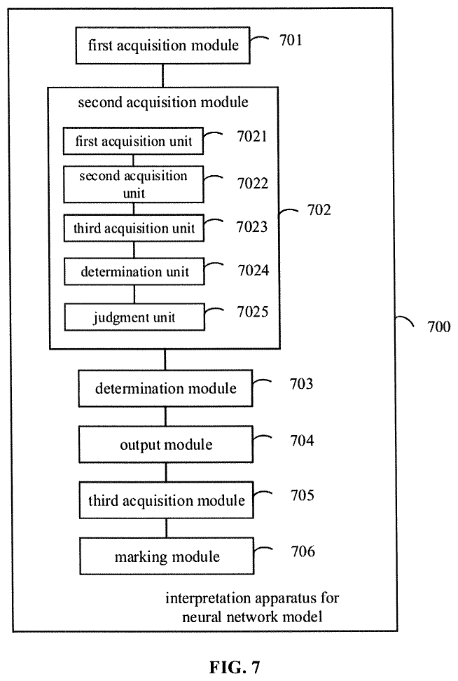

In the embodiment of the present disclosure, FIG. 7 is a schematic diagram showing an interpretation apparatus for a neural network model according to another embodiment of the present disclosure. As shown in FIG. 7, the interpretation apparatus 700 for the neural network model may include a first acquisition module 701, a second acquisition module 702, a determination module 703, an output module 704, a third acquisition module 705, and a marking module 706. The second acquisition module 702 may include a first acquisition unit 7021, a second acquisition unit 7022, a third acquisition unit 7023, a determination unit 7024, and a judgment unit 7025.

The third acquisition module 705 is configured to acquire a quantitative relationship between target concepts in two adjacent layers of networks according to the target concepts in the two adjacent layers of networks for any two adjacent layers of networks in the key inference path.

The marking module 706 is configured to mark the quantitative relationship between the target concepts in the two adjacent layers of networks in the key inference path.

In an embodiment of the present disclosure, the first acquisition unit 7021 is configured to acquire a j^{th} layer of network corresponding to the output data, in which j is equal to N, and N is a total number of layers of networks in the neural network model. The second acquisition unit 7022 is configured to acquire a target concept in the it^{h} layer of network. The third acquisition unit 7023 is configured to acquire quantitative relationships between candidate concepts in an i^{th} layer of network and the target concept, respectively, in which i is equal to j minus 1. The determination unit 7024 is configured to determine a target concept in the layer of network according to the candidate concepts in the layer of network and the quantitative relationships. The judgment unit 7025 is configured to subtract 1 from j, and execute acquiring the target concept in the j^{th} layer of network when j is greater than 2; and generate the key inference path according to the target concepts in the layers of networks when j is equal to 2.

In an embodiment of the present disclosure, the determination unit 7024 is specifically configured to acquire importance values of the quantitative relationships; rank the quantitative relationships in a descending order of the importance values of the quantitative relationships to obtain a ranking result; take out the quantitative relationships sequentially according to the ranking result, and acquiring candidate concepts corresponding to the quantitative relationships from the candidate concepts in the layer of network; accumulate estimated values of the candidate concepts corresponding to the quantitative relationships taken out until an accumulated value is greater than a preset threshold; and determine the target concept in the i^{th} layer of network from the candidate concepts corresponding to the quantitative relationships taken out from the ranking result.

In an embodiment of the present disclosure, the interpretation information includes semantic information of the target concept.

In an embodiment of the present disclosure, the interpretation information further includes sample characteristics of a target sample corresponding to the target concept.

The interpretation apparatus for the neural network model provided in the embodiment can effectively interpret the model by analyzing the target concept in the layers of networks layer by layer and providing a user with corresponding interpretation information of each layer of network, thus improving the self-interpretability of the model.

It is to be noted that the collection, storage, use, processing, transmission, provision and disclosure of personal information of users involved in the technical solutions of the present disclosure are all carried out with the consent of the users, and all comply with the provisions of relevant laws and regulations, and do not violate public order and good customs.

According to an embodiment of the present disclosure, the present disclosure also provides an electronic device. The electronic device includes at least one processor, and a memory communicatively connected with the at least one processor for storing instructions executable by the at least one processor. The at least one processor is configured to execute the instructions to perform the interpretation method for the neural network model in the above-mentioned embodiments.

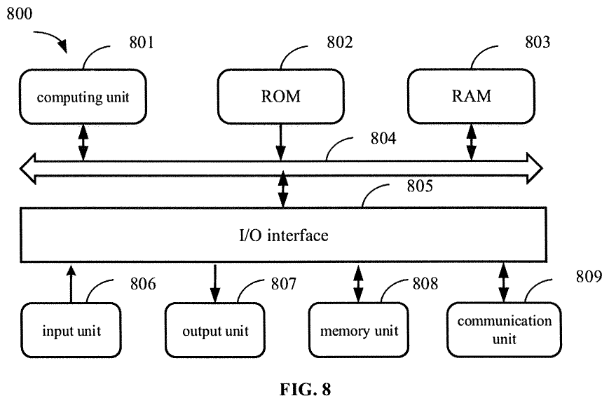

FIG. 8 is a block diagram showing an electronic device used to implement an interpretation method of a neural network model of an embodiment of the present disclosure. The electronic device is intended to represent various forms of digital computers, such as, a laptop computer, a desktop computer, a workstation, a personal digital assistant, a server, a blade server, a mainframe computer, and other suitable computers. The electronic device may also represent various forms of mobile device, such as a personal digital processor, a cellular phone, a smart phone, a wearable device, and other similar computing devices. Components shown herein, their connections and relationships, and their functions are only illustrative, and are not intended to limit the implementations of the present disclosure described and/or claimed herein.

As shown in FIG. 8, the electronic device 800 includes a computing unit 801 that can perform various appropriate actions and processes according to a computer program stored in a read-only memory (ROM) 802 or loaded from a memory unit 808 into a random access memory (RAM) 803. In the RAM 803, various programs and data required for the operation of the device 800 may also be stored. The computing unit 801, the ROM 802, and the RAM 803 are connected to each other via a bus 804. An input/output (I/O) interface 805 is also connected to the bus 804.

A plurality of components in the electronic device 800 are connected to the I/O interface 805, including an input unit 806, such as a keyboard, and a mouse; an output unit 807, such as various types of displays, and speakers; a memory unit 808, such as a magnetic disk, and an optical disk; and a communication unit 809, such as a network card, a modulator-demodulator, and a wireless communication transceiver. The communication unit 809 allows the electronic device 800 to exchange information/data with other devices via a computer network such as Internet and/or various telecommunications networks.

The computing unit 801 may be various generic and/or specific processing assemblies with processing and computational capabilities. Some examples of the computing unit 801 include, but are not limited to, central processing units (CPUs), graphics processing units (GPUs), various specific artificial intelligence (AI) computing chips, various computing units that run machine learning model algorithms, digital signal processors (DSPs), and any appropriate processors, controllers, and microcontrollers. The computing unit 801 is configured to execute the various methods and processes described above, for example the interpretation method for the neural network model. For example, in some embodiments, the interpretation method for the neural network model may be implemented as a computer software program that is tangibly embodied on a machine-readable medium, such as the memory unit 808. In some embodiments, part or all of computer programs may be loaded and/or installed on the electronic device 800 via the ROM 802 and/or the communication unit 809. When a computer program is loaded into the RAM 803 and executed by the computing unit 801, one or more steps of the interpretation method for the neural network model described above may be executed. Alternatively, in other embodiments, the computing unit 801 may be configured to execute the interpretation method for the neural network model by any other suitable means (e.g., by means of a firmware).

Various implementations of the systems and techniques above-described herein may be implemented in digital electronic circuit systems, integrated circuit systems, field programmable gate arrays (FPGAs), application specific integrated circuits (ASICs), application specific standard products (ASSPs), system-on-chip (SOC) systems, load programmable logic devices (CPLDs), computer hardware, firmware, software, and/or combinations thereof. These various embodiments may include being implemented in one or more computer programs executable and/or interpretable on a programmable system including at least one programmable processor. The programmable processor may be a specific or generic programmable processor that may receive data and instructions from a storage system, at least one input device, and at least one output device, and transmit data and instructions to the storage system, the at least one input device, and the at least one output device.

Program codes for implementing the method in embodiments of the present disclosure may be written in one or more programming languages in any combination. These program codes may be provided to a processor or a controller of a generic computer, a specific computer or other programmable data processing devices, such that the program codes, when executed by the processor or the controller, causes the functions/operations specified in the flowcharts and/or block diagrams to be implemented. The program codes may be entirely executed on a machine, partly executed on the machine, partly executed on the machine and partly executed on a remote machine as a stand-alone software package, or entirely executed on the remote machine or a server.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any suitable combination of the foregoing. More specific examples of the machine-readable storage medium may include an electrical connection based on one or more wires, a portable computer disk, a hard disk, a random access memory (RAM), a read only memory (ROM), an erasable programmable read only memory (EPROM or a flash memory), a fiber optic, a portable compact disk read only memory (CD-ROM), an optical storage device, a magnetic storage device, or any suitable combination of the foregoing.

To provide interaction with a user, the systems and techniques described herein may be implemented on a computer having a display apparatus (e.g., a cathode ray tube (CRT) or a liquid crystal display (LCD) monitor) for displaying information to the user; and a keyboard and a pointing apparatus (e.g., a mouse or a trackball) through which the user can provide an input to the computer. Other kinds of apparatuses can also be used to provide interaction with the user; for example, a feedback provided to the user can be any form of sensory feedback (e.g., a visual feedback, an auditory feedback, or a tactile feedback); and the input from the user may be received in any form (including acoustic input, voice input, or tactile input).

The systems and techniques described herein can be implemented in a computing system including a back-end component (e.g., as a data server), a computing system including a middleware component (e.g., an application server), a computing system including a front-end component (e.g., a user computer having a graphical user interface or a web browser through which a user may interact with implementations of the systems and techniques described herein), or a computing system that includes any combination of the back-end component, the middleware component, or the front-end component. The components of the system may be connected with each other via any form or medium of digital data communication (e.g., a communication network). An example of the communication network includes a local area network (LAN), a wide area network (WAN), and an Internet.

The computer system may include a client and a server. The client and the server are generally remote from each other and usually interact with each other through a communication network. A relationship of the client and the server is generated by a computer program that runs on a corresponding computer and has a client-server relationship with each other. The server can be a cloud server, a server for a distributed system, or a server combined with a blockchain.

It is to be noted that artificial intelligence is a subject that enables computers to simulate some thinking processes and intelligent bithaviors (such as learning, reasoning, thinking, planning, and the like), involving both hardware-level and software-level technologies. Artificial intelligence hardware technologies generally include technologies such as sensors, specific artificial intelligence chips, cloud computing, distributed storage, big data processing and the like. Artificial intelligence software technologies mainly include computer vision technology, speech recognition technology, natural language processing technology, machine learning/deep learning, big data processing technology, knowledge mapping technology and so on.

According to an embodiment of the present disclosure, the present disclosure also provides a computer-readable storage medium having stored therein a computer program that, when executed by a processor, causes the processor to implement the interpretation method for the neural network model in the above-mentioned embodiments.

According to an embodiment of the present disclosure, the present disclosure also provides a computer program product including instructions that, when executed by a processor, causes the processor to implement the interpretation method for the neural network model in the above-mentioned embodiments.

It can be understood that various forms of flowcharts shown above can be used to reorder, add, or remove steps. For example, the steps described in the present disclosure may be performed in parallel, sequentially, or in a different order. There is no limitation herein as long as the desired results of the technical solutions disclosed herein can be realized.

The above-mentioned specific embodiments do not constitute a limitation on the scope of protection of the present disclosure. It can be understood by those skilled in the art that various modifications, combinations, sub-combinations and substitutions can be made depending on design requirements and other factors. Any modifications, equivalent replacements, and improvements made within the spirit and principle of the present disclosure can be included within the protection scope of the present disclosure.

What is claimed is:

1. An interpretation method for a neural network model, comprising:
acquiring input data and output data corresponding to the input data of a neural network model, wherein the neural network model comprises layers of networks connected sequentially, and each layer of network corresponds to a plurality of candidate concepts;
acquiring a key inference path through which the output data is obtained by the neural network model based on the input data, wherein the key inference path comprises target concepts respectively used by the layers of networks when the input data is processed in the neural network model, wherein the target concepts are selected from the plurality of candidate concepts;
determining interpretation information corresponding to the layers of networks according to the target concepts corresponding to the layers of networks, respectively; and
outputting the key inference path and the interpretation information.

2. The method of claim 1, wherein acquiring the key inference path through which the output data is obtained by the neural network model based on the input data comprises:
acquiring a j^{th} layer of network corresponding to the output data, wherein j is equal to N, and N is a total number of layers of networks in the neural network model;
acquiring a target concept in the i^{th} layer of network;
acquiring quantitative relationships between candidate concepts in an i^{th} layer of network and the target concept, respectively, wherein i is equal to j minus 1;
determining a target concept in the layer of network according to the candidate concepts in the i^{th} layer of network and the quantitative relationships;
subtracting 1 from j, and executing acquiring the target concept in the j^{th} layer of network when j is greater than 2; and
generating the key inference path according to the target concepts in the layers of networks when j is equal to 2.

3. The method of claim 2, wherein determining the target concepts of the i^{th} layer of network according to the candidate concepts in the i^{th} layer of network and the quantitative relationships comprises:
acquiring importance values of the quantitative relationships;
ranking the quantitative relationships in a descending order of the importance values of the quantitative relationships to obtain a ranking result;
taking out the quantitative relationships sequentially according to the ranking result, and acquiring candidate concepts corresponding to the quantitative relationships from the candidate concepts in the i^{th} layer of network;
accumulating estimated values of the candidate concepts corresponding to the quantitative relationships taken out until an accumulated value is greater than a preset threshold; and
determining the target concept in the i^{th} layer of network from the candidate concepts corresponding to the quantitative relationships taken out from the ranking result.

4. The method of claim 1, wherein the interpretation information comprises semantic information of the target concept.

5. The method of claim 4, wherein the interpretation information further comprises sample characteristics of a target sample corresponding to the target concept.

6. The method of claim 1, further comprising:
acquiring a quantitative relationship between target concepts in two adjacent layers of networks according to the target concepts in the two adjacent layers of networks for any two adjacent layers of networks in the key inference path; and
marking the quantitative relationship between the target concepts in the two adjacent layers of networks in the key inference path.

7. An electronic device, comprising:
at least one processor; and
a memory communicatively connected with the at least one processor for storing instructions executable by the at least one processor;
wherein the at least one processor is configured to:
acquire input data and output data corresponding to the input data of a neural network model, wherein the neural network model comprises layers of networks connected sequentially, and each layer of network corresponds to a plurality of candidate concepts;
acquire a key inference path through which the output data is obtained by the neural network model based on the input data, wherein the key inference path comprises target concepts respectively used by the layers of networks when the input data is processed in the neural network model, wherein the target concepts are selected from the plurality of candidate concepts;
determine interpretation information corresponding to the layers of networks according to the target concepts corresponding to the layers of networks, respectively; and
output the key inference path and the interpretation information.

8. The electronic device of claim 7, wherein the at least one processor is configured to:
acquire a j^{th} layer of network corresponding to the output data, wherein j is equal to N, and N is a total number of layers of networks in the neural network model;
acquire a target concept in the j^{th} layer of network;
acquire quantitative relationships between candidate concepts in an i^{th} layer of network and the target concept, respectively, wherein i is equal to j minus 1;
determine a target concept in the i^{th} layer of network according to the candidate concepts in the layer of network and the quantitative relationships;
subtract 1 from j, and execute acquiring the target concept in the j^{th} layer of network when j is greater than 2; and
generate the key inference path according to the target concepts in the layers of networks when j is equal to 2.

9. The electronic device of claim 8, wherein the at least one processor is configured to:
acquire importance values of the quantitative relationships;
rank the quantitative relationships in a descending order of the importance values of the quantitative relationships to obtain a ranking result;
take out the quantitative relationships sequentially according to the ranking result, and acquiring candidate concepts corresponding to the quantitative relationships from the candidate concepts in the layer of network;
accumulate estimated values of the candidate concepts corresponding to the quantitative relationships taken out until an accumulated value is greater than a preset threshold; and
determine the target concept in the layer of network from the candidate concepts corresponding to the quantitative relationships taken out from the ranking result.

10. The electronic device of claim 7, wherein the interpretation information comprises semantic information of the target concept.

11. The electronic device of claim 10, wherein the interpretation information further comprises sample characteristics of a target sample corresponding to the target concept.

12. The electronic device of claim 7, wherein the at least one processor is configured to:
acquire a quantitative relationship between target concepts in two adjacent layers of networks according to the target concepts in the two adjacent layers of networks for any two adjacent layers of networks in the key inference path; and
mark the quantitative relationship between the target concepts in the two adjacent layers of networks in the key inference path.

13. A non-transitory computer-readable storage medium having stored therein computer instructions that, when executed by a computer, cause the computer to perform:
acquiring input data and output data corresponding to the input data of a neural network model, wherein the neural network model comprises layers of networks connected sequentially, and each layer of network corresponds to a plurality of candidate concepts;
acquiring a key inference path through which the output data is obtained by the neural network model based on the input data, wherein the key inference path comprises target concepts respectively used by the layers of networks when the input data is processed in the neural network model, wherein the target concepts are selected from the plurality of candidate concepts;
determining interpretation information corresponding to the layers of networks according to the target concepts corresponding to the layers of networks, respectively; and
outputting the key inference path and the interpretation information.

14. The non-transitory computer-readable storage medium of claim 13, wherein acquiring the key inference path through which the output data is obtained by the neural network model based on the input data comprises:
acquiring a j^{th} layer of network corresponding to the output data, wherein j is equal to N, and N is a total number of layers of networks in the neural network model;
acquiring a target concept in the j^{th} layer of network;
acquiring quantitative relationships between candidate concepts in an i^{th} layer of network and the target concept, respectively, wherein i is equal to j minus 1;
determining a target concept in the 1 layer of network according to the candidate concepts in the i^{th} layer of network and the quantitative relationships;
subtracting 1 from j, and executing acquiring the target concept in the j^{th} layer of network when j is greater than 2; and
generating the key inference path according to the target concepts in the layers of networks when j is equal to 2.

15. The non-transitory computer-readable storage medium of claim 14, wherein determining the target concepts of the i^{th} layer of network according to the candidate concepts in the i^{th} layer of network and the quantitative relationships comprises:
acquiring importance values of the quantitative relationships;
ranking the quantitative relationships in a descending order of the importance values of the quantitative relationships to obtain a ranking result;
taking out the quantitative relationships sequentially according to the ranking result, and acquiring candidate concepts corresponding to the quantitative relationships from the candidate concepts in the i^{th} layer of network;
accumulating estimated values of the candidate concepts corresponding to the quantitative relationships taken out until an accumulated value is greater than a preset threshold; and
determining the target concept in the i^{th} layer of network from the candidate concepts corresponding to the quantitative relationships taken out from the ranking result.

16. The non-transitory computer-readable storage medium of claim 13, wherein the interpretation information comprises semantic information of the target concept.

17. The non-transitory computer-readable storage medium of claim 16, wherein the interpretation information further comprises sample characteristics of a target sample corresponding to the target concept.

18. The non-transitory computer-readable storage medium of claim 13, wherein the computer is further configured to:
acquire a quantitative relationship between target concepts in two adjacent layers of networks according to the target concepts in the two adjacent layers of networks for any two adjacent layers of networks in the key inference path; and
mark the quantitative relationship between the target concepts in the two adjacent layers of networks in the key inference path.
